(19) United States
(12) Patent Application Publication
(10) Pub. No.: US 2023/0331162 A1
(43) Pub. Date: Oct. 19, 2023

(54) DISPLAY CONTROLLER

(71) Applicant: Panasonic Intellectual Property Management Co., Ltd., Osaka (JP)

(72) Inventors: Masayoshi MICHIGUCHI, Kanagawa (JP); Yusuke TSUJI, Kanagawa (JP); Naotaka EGAWA, Tokyo (JP); Michio OBORA, Kanagawa (JP); Yoshimasa OKABE, Kanagawa (JP); Masaki SATO, Kanagawa (JP)

(73) Assignee: Panasonic Intellectual Property Management Co., Ltd., Osaka (JP)

(21) Appl. No.: 18/132,077

(22) Filed: Apr. 7, 2023

(30) Foreign Application Priority Data
Apr. 13, 2022 (JP) 2022-066500

(51) Int. Cl. B60R 1/27; B60R 1/28; B60R 1/31

(52) U.S. Cl. CPC B60R 1/27; B60R 1/28; B60R 1/31; B60R 2300/602; B60R 2300/303; B60R 2300/402

(57) ABSTRACT

A display controller includes: an image generator configured to generate a three-dimensional image of surroundings of a vehicle and output a display image; an instruction determiner configured to determine an instruction of a user in accordance with a position operated by the user; and a viewpoint changer configured to change a viewpoint parameter related to generation of the three-dimensional image on a basis of the instruction of the user, wherein the instruction determiner sets a plurality of regions corresponding to different viewpoint parameters in the display image, the instruction determiner determines the instruction of the user on a basis of a region where the position operated by the user, the viewpoint changer changes the viewpoint parameter in accordance with the instruction of the user, and the instruction determiner sets the plurality of regions in the three-dimensional image after a change.

### TECHNICAL FIELD

The present disclosure relates to a display controller that controls a display of an image representing the surroundings of a vehicle.

### BACKGROUND ART

In the related art, a technique for generating and displaying a three-dimensional image of a vehicle and its surroundings as viewed from a virtual viewpoint based on the image output from a plurality of in-vehicle cameras that captures the surroundings of the vehicle is known.

For example PTL 1 discloses an image display device including: a display control means that displays on a screen a synthetic image (three-dimensional image) and a plurality of buttons associated with a plurality of reference virtual viewpoints of the same height and different positions of the virtual viewpoints; and a detection means that detects a user operation for changing the position of the virtual viewpoint of the synthetic image displayed on the screen, in which a generation means generates a synthetic image as viewed from the reference virtual viewpoint selected through the operation of the plurality of buttons, and the position of the virtual viewpoint of the synthetic image is changed based on the user operation.

### CITATION LIST

### Patent Literature

PTL 1
Japanese Patent Application Laid-Open No. 2015-076062

### SUMMARY OF INVENTION

### Technical Problem

However, in the system that changes the position of the viewpoint of the synthetic image in accordance with the button operated by the user, the relationship between the movement direction of the viewpoint and the buttons may not be intuitively connected, resulting in poor usability (feeling).

An object of the present disclosure is to provide a display controller with improved usability.

### Solution to Problem

A display controller according to an aspect of the present disclosure includes: an image generator configured to generate a three-dimensional image of surroundings of a vehicle and output a display image to be displayed on a display device on a basis of the three-dimensional image, the three-dimensional image being generated on a basis of images captured by a plurality of in-vehicle cameras configured to capture the surroundings of the vehicle; an instruction determiner configured to determine an instruction of a user in accordance with a position operated by the user in the display image displayed on the display device; and a viewpoint changer configured to change a viewpoint parameter related to generation of the three-dimensional image on a basis of the instruction of the user determined by the instruction determiner. The instruction determiner sets a plurality of regions corresponding to different viewpoint parameters in the display image. The instruction determiner determines the instruction of the user on a basis of a region where the position operated by the user belongs among the plurality of regions. The viewpoint changer changes the viewpoint parameter in accordance with the instruction of the user. The instruction determiner sets the plurality of regions in the three-dimensional image after a change.

A display controller according to an aspect of the present disclosure includes: an image generator configured to generate a three-dimensional image of surroundings of a vehicle and output a display image to be displayed on a display device on a basis of the three-dimensional image, the three-dimensional image being generated on a basis of images captured by a plurality of in-vehicle cameras configured to capture the surroundings of the vehicle; an instruction determiner configured to determine an instruction of a user on a basis of a direction designated by an operation by the user on the display image displayed on the display device; and a viewpoint changer configured to change a viewpoint parameter related to generation of the three-dimensional image in accordance with the instruction of the user determined by the instruction determiner. The instruction determiner sets a plurality of reference directions corresponding to different viewpoint parameters. The instruction determiner determines a reference direction close to the direction designated by the operation by the user among the plurality of reference direction. The viewpoint changer changes the viewpoint parameter on a basis of a result determined by the instruction determiner. The instruction determiner sets the plurality of reference directions in the three-dimensional image in accordance with a viewpoint after a change.

A display controller according to an aspect of the present disclosure includes: an image generator configured to generate a three-dimensional image of surroundings of a vehicle and output a display image to be displayed on a display device on a basis of the three-dimensional image, the three-dimensional image being generated on a basis of images captured by a plurality of in-vehicle cameras configured to capture the surroundings of the vehicle; and a viewpoint changer configured to change a viewpoint parameter on a basis of a position of a swipe and one of an operation amount and an operation speed of the swipe when the swipe is performed by a user on the three-dimensional image displayed on the display device.

### Advantageous Effects of Invention

According to the present disclosure, the usability can be improved.

### BRIEF DESCRIPTION OF DRAWINGS

FIG. 1 is a schematic view illustrating a vehicle according to an embodiment of the present disclosure as viewed from directly above;

FIG. 2 is a block diagram illustrating configurations of a display system and a display controller according to the embodiment of the present disclosure;

FIG. 3 is a schematic view illustrating a configuration of a computer hardware included in the display controller according to the embodiment of the present disclosure;

FIG. 4 is a schematic view illustrating a first example of a three-dimensional image according to the embodiment of the present disclosure;

FIG. 5 is a schematic view illustrating a second example of a three-dimensional image according to the embodiment of the present disclosure;

FIG. 6 is a schematic view illustrating a third example of a three-dimensional image according to the embodiment of the present disclosure;

FIG. 7 is a schematic view illustrating an example of a plurality of regions according to the embodiment of the present disclosure;

FIG. 8 is a schematic view illustrating another example of a plurality of regions according to the embodiment of the present disclosure;

FIG. 9 is a flow flowchart of an operation of the display controller according to the embodiment of the present disclosure;

FIG. 10 is a schematic view illustrating an exemplary division of a plurality of regions according to modification 1 of the present disclosure;

FIG. 11 is a schematic view illustrating another exemplary division of a plurality of regions according to modification 1 of the present disclosure;

FIG. 12 is a schematic view illustrating a dead region according to modification 2 of the present disclosure;

FIG. 13 is a schematic view illustrating an image of a first effect process according to modification 3 of the present disclosure;

FIG. 14 is a schematic view illustrating an image of a second effect process according to modification 3 of the present disclosure;

FIG. 15 is a schematic view illustrating an image of a third effect process according to modification 3 of the present disclosure;

FIG. 16 is a schematic view illustrating an exemplary viewpoint change according to modification 4 of the present disclosure;

FIG. 17 is a schematic view illustrating a line of sight and an operation direction on a three-dimensional image according to modification 5 of the present disclosure; and

FIG. 18 is a schematic view illustrating an operation direction on a three-dimensional image according to modification 6 of the present disclosure.

### DESCRIPTION OF EMBODIMENTS

An embodiment of the present disclosure is described below with reference to the drawings. Note that common components among the drawings are denoted with the same reference numerals, and description thereof will be omitted as necessary.

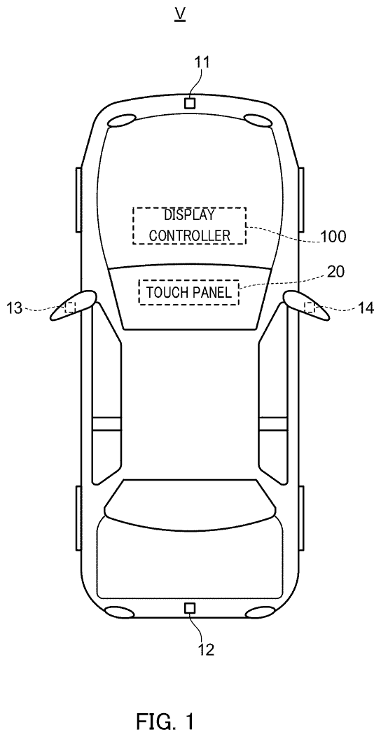

First, vehicle V of the present embodiment is described with reference to FIG. 1. FIG. 1 is a schematic view of vehicle V as viewed from directly above. Note that in the present embodiment, a case where vehicle V is a passenger car is described as an example, but the type of vehicle is not limited to a passenger car.

Vehicle V includes a plurality of in-vehicle cameras for capturing the surroundings of vehicle V. More specifically, as illustrated in FIG. 1, vehicle V includes front camera 11 that captures the front side (including the road surface on the front side) of vehicle V, rear camera 12 that captures the rear side (including the road surface on the rear side) of vehicle V, left camera 13 that captures the left side (including the road surface on the left side) of vehicle V, and right camera 14 that captures the right side (including the road surface on the right side) of vehicle V. Each camera is provided with a depression angle for capturing the road surface. In addition, the viewing angle of each camera is 190 degrees or greater, and the whole circumference of vehicle V can be captured with the four cameras.

Note that in the present embodiment, the number the mounted in-vehicle cameras is four as an example, but the number of the mounted in-vehicle cameras is not limited to this. In addition, the mount position of the in-vehicle camera is not limited to the position illustrated in FIG. 1. For example, lateral rear monitoring cameras with a viewing angle of about 45 degrees may be additionally provided to synthesize the display image from the images captured with a total of six in-vehicle cameras.

As illustrated in FIG. 1, vehicle V includes touch panel 20 and display controller 100.

Touch panel 20 is an input/output device provided in the vehicle interior, receives various operations of the user (e.g., a passenger of vehicle V), and displays various images, for example. It can be said that touch panel 20 is an operation reception device as well as a display device.

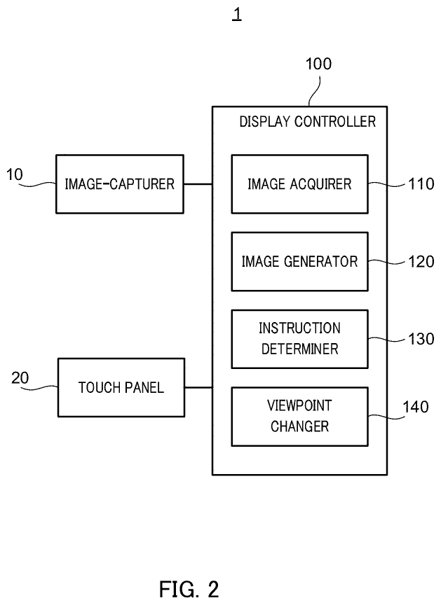

Display controller 100 is a computer that generates a three-dimensional image (described in detail later) based on the image captured by the above-described in-vehicle camera, and displays it on touch panel 20. Display controller 100 is implemented with an ECU (Electronic Control Unit), for example. Although not illustrated in the drawings, display controller 100 is electrically connected with the above-described in-vehicle camera and touch panel 20. Details of display controller 100 are described later with reference to FIG. 2, etc.

Hereinabove, vehicle V is described.

Next, a configuration of display system 1 and display controller 100 of the present embodiment is described with reference to FIG. 2. FIG. 2 is a block diagram illustrating an exemplary configuration of display system 1 and display controller 100 of the present embodiment.

As illustrated in FIG. 2, display system 1 includes image-capturer 10, touch panel 20, and display controller 100. Note that display system 1 may be referred to as “vehicle-surroundings monitoring device”.

Image-capturer 10 corresponds to the above-described in-vehicle camera (that is, front camera 11, rear camera 12, left camera 13, and right camera 14 illustrated in FIG. 1).

As illustrated in FIG. 2, display controller 100 includes image acquirer 110, image generator 120, instruction determiner 130, and viewpoint changer 140. Note that FIG. 2 does not limit the physical configuration, the number of parts, or functional inclusions of the vehicle-surroundings monitoring device. For example, a plurality of touch panels 20 may be provided, and instruction determiner 130 may be provided as one of the functions of viewpoint changer 140.

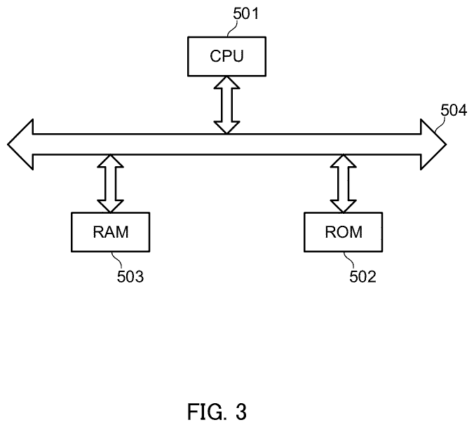

In addition, as hardware, display controller 100 includes central processing unit (CPU) 501, read only memory (ROM) 502 storing a computer program, and random access memory (RAM) 503 as illustrated in FIG. 3, for example. CPU 501, ROM 502, and RAM 503 are connected via bus 504.

Each function of display controller 100 described in the specification is implemented when a computer program read from ROM 502 is executed by CPU 501. In addition, this computer program may be provided to the user and the like in the form of a predetermined recording medium recording it, or through a network.

Image acquirer 110 acquires captured images (more specifically, a front image captured by front camera 11, a rear image captured by rear camera 12, a left image captured by left camera 13, and a right image captured by right camera 14) from image-capturer 10, and performs image processing (such as distortion correction) for improving the image quality on the captured image.

Image generator 120 generates a three-dimensional image based on the captured image having been subjected to the above-mentioned image processing, and outputs a display image based on the three-dimensional image. Touch panel 20 displays the display image, and the user can monitor the surroundings of the vehicle by viewing the display image.

The display image is a synthetic image of a vehicle image three-dimensionally showing vehicle V (hereinafter referred to simply as vehicle image) superimposed on an image three-dimensionally showing the surroundings of vehicle V generated from the captured image, and is an image as viewed from obliquely above vehicle V and its surroundings from a virtual viewpoint (hereinafter referred to simply as viewpoint), for example. The image three-dimensionally showing the surroundings of vehicle V generated based on the captured image may be referred to as three-dimensional image, or an image including the vehicle image added to this may be referred to as three-dimensional image. In addition, since the three-dimensional image generated based on the captured image occupies a main portion of the display image, it can be said that display controller 100 outputs a three-dimensional image as the display image. In the image of the surroundings of the vehicle and the vehicle image, the portion close to the viewpoint is large and the portion remote from viewpoint is small in the display image. As such, the three-dimensional image appears different depending on the position of the viewpoint.

It is assumed that the viewpoint in the present embodiment (and the modifications described later) is a viewpoint located at a position slightly higher than vehicle V around vehicle V, for example. Therefore, the viewpoint should be described, for example, as “front right and upper side”, but the “upper side” thereof will be omitted because every viewpoint is on the “upper side”.

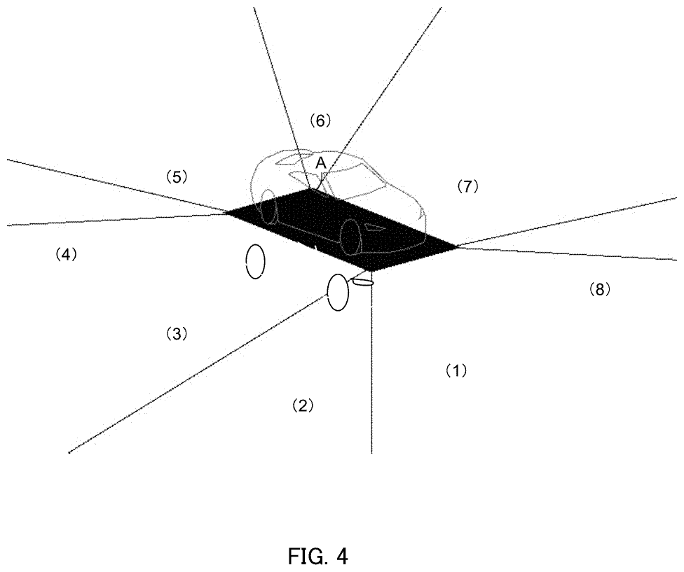

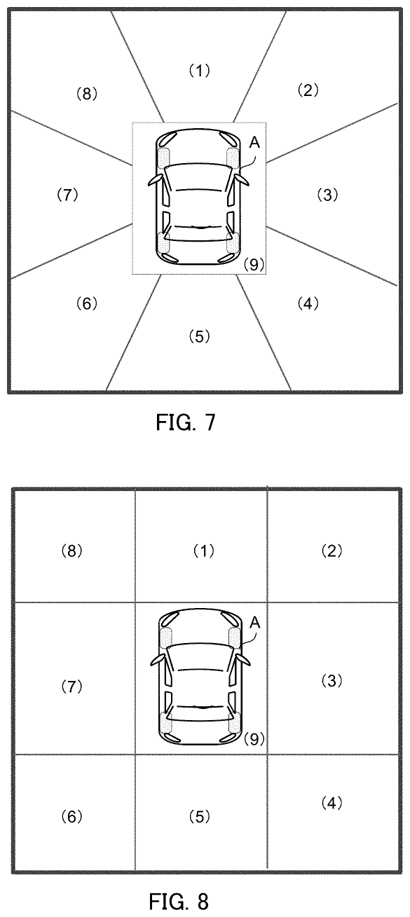

An example of the three-dimensional image is described below with reference to FIGS. 4 to 8. FIGS. 4 to 6 are schematic views illustrating an exemplary three-dimensional image. FIGS. 7 and 8 are schematic views illustrating an exemplary division of a plurality of regions set in a three-dimensional image.

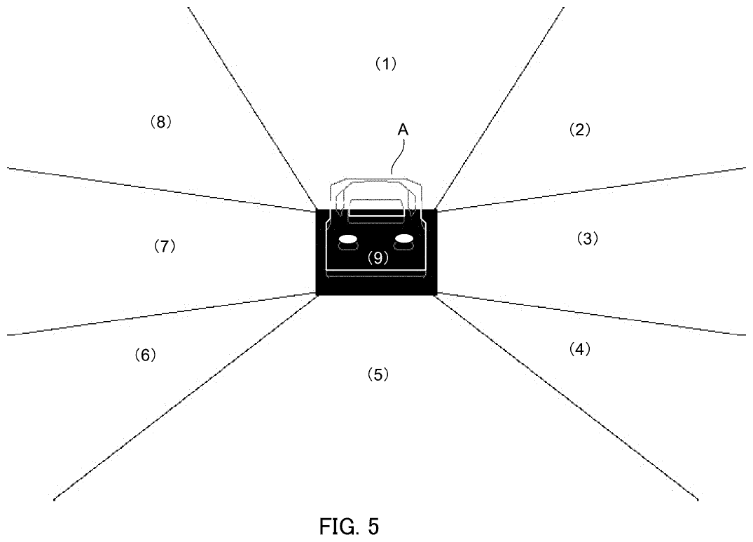

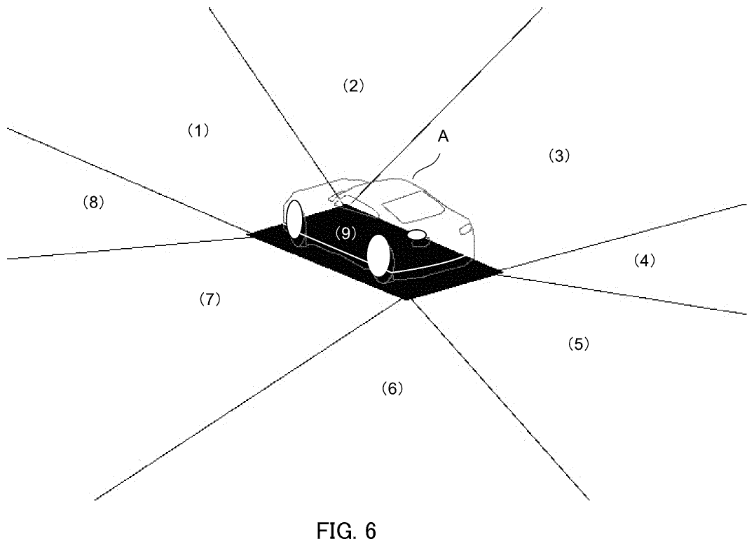

The three-dimensional image of FIG. 4 is an image showing an image of vehicle V as viewed from above from a viewpoint on a front right side of vehicle V. The three-dimensional image of FIG. 5 is an image showing an image of vehicle V as viewed from above from a viewpoint right behind vehicle V. The three-dimensional image of FIG. 6 is an image showing an image of vehicle V as viewed from above from a viewpoint on the rear left side of vehicle V.

Vehicle image A illustrated in FIGS. 4 to 6 is not an image based on a captured image, but is an image synthesized from a three-dimensional model (e.g., a polygon model) of vehicle V. Note that the process of synthesizing a two-dimensional vehicle image A from a three-dimensional model of vehicle V may not necessarily be performed in real time, and may be executed outside display controller 100 in advance. For example, a plurality of vehicle images A with different viewpoints synthesized by an external computer may be stored in advance in image generator 120 such that one of the plurality of vehicle images A is selected in accordance with the viewpoint selected by viewpoint changer 140. On the other hand, in FIGS. 4 to 6, a real time image of the surroundings of vehicle V (e.g., images of buildings, vehicles, people and the like that are present around vehicle V at the time when the image is captured) is displayed around vehicle image A on the basis of the above-described captured image.

In addition, as illustrated in FIGS. 4 to 6, in the three-dimensional image, a plurality of regions (1) to (9) is set. Region (9) is a region where vehicle image A is displayed. Regions (1) to (8) around region (9) display the image of the surroundings of vehicle V. In addition, regions (1) to (8) correspond to respective different viewpoints.

FIG. 7 illustrates exemplary settings of regions (1) to (9). FIG. 7 is a schematic view of regions (1) to (9) as viewed from directly above. As illustrated in FIG. 7, each boundary line sectioning regions (1) to (8) (hereinafter referred to simply as boundary line) is set in a radial form with the center of region (9) at the center. The angle between adjacent boundary lines is 45 degrees, for example.

In regions (1) to (9) set in the above-described manner, the positions and areas of regions (1) to (9) differ for each three-dimensional image (or viewpoint) when the three-dimensional image is actually displayed on touch panel 20 as illustrated in FIGS. 4 to 6. This gives the user a sense of perspective.

Note that the numbers (1 to 9 in parentheses) representing the regions illustrated in FIGS. 4 to 6 are not displayed on touch panel 20. On the other hand, the boundary line may be or may not be displayed on touch panel 20. For example, the boundary line may be displayed on touch panel 20 only for a predetermined time (e.g., several seconds) from the start of the display of the three-dimensional image, or may be displayed only when touched, or, may be displayed only when the touched position is close to the boundary line. By not displaying the boundary line, the visual recognition of the vehicle-surroundings image is not blocked. By displaying the boundary line when touched or when the finger makes contact with the boundary line, it is possible to touch the position that is reliably determined in the next touch.

In addition, here, three three-dimensional images corresponding to three viewpoints are described as an example, but three-dimensional images corresponding to other viewpoints may be generated.

In addition, here, the number of regions is nine as an example, but this is not limitative.

In addition, here, the boundary line is radially set as illustrated in FIG. 7 as an example, but this is not limitative. For example, as illustrated in FIG. 8, the boundary line may be composed of a horizontal line and a vertical line. Also in this case, when the three-dimensional image is actually displayed on touch panel 20, the positions and areas of regions (1) to (9) change for each three-dimensional image (viewpoint).

In addition, here, vehicle image A is included in the three-dimensional image as an example, but this is not limitative. For example, the three-dimensional image may be composed only of an image generated based on the captured image, or another image representing the orientation of vehicle V (e.g., an image of arrow and the like) may be added instead of vehicle image A. In addition, three-dimensional image may be referred to as output image.

Hereinabove, examples of the three-dimensional image are described. In the following, description will be made by returning to FIG. 2.

When a predetermined three-dimensional image is displayed on touch panel 20 and an operation of instructing to change the viewpoint (hereinafter referred to as viewpoint change operation) is performed by the user, instruction determiner 130 determines the position of the instructed viewpoint. When generating a three-dimensional image, it is necessary to identify, as well as the viewpoint, an eye direction indicating the viewing direction based on the viewpoint. The viewpoint and eye direction are collectively referred to as viewpoint parameter. In addition, the line of sight means a direction, and therefore the eye direction may be simply referred to as line of sight. When generating a three-dimensional image, the vehicle-surroundings image with vehicle V at the center is output as a display image, and it is preferable to direct the line of sight toward vehicle V at all times. On the basis of this premise, the line of sight is uniquely determined when the viewpoint is set, and therefore the viewpoint parameter need only include viewpoint information. In addition, in the case where it is additionally assumed that as the premise the viewpoint is located on a concentric circle around the vehicle V, the viewpoint is uniquely determined when the line of sight is determined, and therefore the viewpoint parameter need only include information about the line of sight. Therefore, it can be said that instruction determiner 130 determines the instructed viewpoint parameter, and this viewpoint parameter may be a viewpoint or a line of sight.

In the present embodiment, the user can make a viewpoint change instruction by touching with the finger or the like the desired position in the three-dimensional image displayed on touch panel 20 (an example of the viewpoint change operation). For example, when the three-dimensional image of FIG. 4 is displayed on touch panel 20 (or when the viewpoint is on a front right side of vehicle V) and the user desires to change the viewpoint to the side right behind vehicle V, the user touches the region (5) on the three-dimensional image of FIG. 4. Then, instruction determiner 130 determines that the touched position belongs to region (5) on the basis of the detection signal from touch panel 20 (a signal indicating the touched position), and that the instructed viewpoint is on the side right behind vehicle V.

Viewpoint changer 140 changes the viewpoint of the three-dimensional image to the viewpoint determined by instruction determiner 130, and displays the three-dimensional image corresponding to the changed viewpoint on touch panel 20. In addition, at this time, viewpoint changer 140 changes a plurality of regions (more specifically, positions and areas) in the three-dimensional image in accordance with the changed viewpoint.

In the case where the displayed three-dimensional image is the three-dimensional image of FIG. 4 and the viewpoint determined by instruction determiner 130 is on the side right behind vehicle V, viewpoint changer 140 changes the viewpoint from the front right side to the side right behind vehicle V, and outputs the three-dimensional image of FIG. 5 as viewed from that viewpoint, for example. In this manner, touch panel 20 displays the three-dimensional image of FIG. 5. In addition, at this time, viewpoint changer 140 changes regions (1) to (8) illustrated in FIG. 4 to regions (1) to (8) as viewed from the viewpoint determined by instruction determiner 130. That is, the positions and areas of regions (1) to (8) of FIG. 4 are changed to the positions and areas of regions (1) to (8) illustrated in FIG. 5.

Note that in the present embodiment, to clarify the description, an example case where the function of display controller 100 is composed of the four components, namely, image acquirer 110, image generator 120, instruction determiner 130, and viewpoint changer 140, as an example, but this is not limitative. For example, image generator 120 may also have the function of image acquirer 110, and viewpoint changer 140 may also have the function of instruction determiner 130 (the same applies to the modifications described later).

Hereinabove, the configurations of display system 1 and display controller 100 of the present embodiment are described.

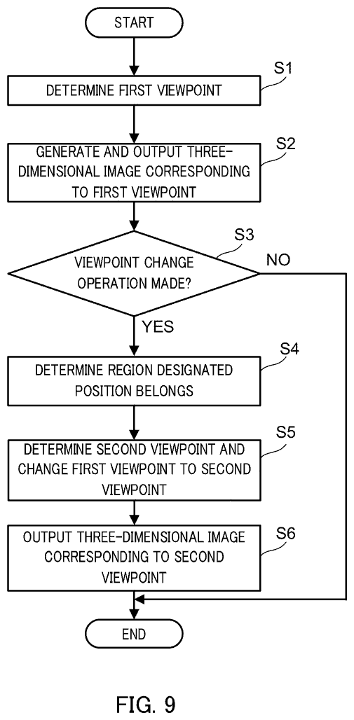

Next, with reference to FIG. 9, an operation of display controller 100 is described. FIG. 9 is a flow flowchart illustrating an operation of display controller 100.

The flowchart illustrated in FIG. 9 is started when an operation of instructing to display the three-dimensional image is made by the user in the state where the three-dimensional image is not displayed on touch panel 20, for example. In addition, in this case, image acquirer 110 acquires the captured image from image-capturer 10, and executes a predetermined image process.

First, image generator 120 determines the first viewpoint (step S1).

This first viewpoint may be a viewpoint set in advance, or a viewpoint of the three-dimensional image displayed last time.

Next, image generator 120 generates a three-dimensional image corresponding to the first viewpoint on the basis of the captured image image-processed by image acquirer 110, and outputs it to touch panel 20 (step S2). In this manner, touch panel 20 displays the three-dimensional image corresponding to the first viewpoint, and the user can visually recognize it.

Next, instruction determiner 130 determines whether a viewpoint change operation by the user is made on the displayed three-dimensional image on the basis of the presence/absence of a detection signal from touch panel 20 (step S3). More specifically, instruction determiner 130 determines whether the position designation is made on the displayed three-dimensional image.

When the viewpoint change operation is not performed (step S3:NO), the procedure is completed. Note that when the viewpoint change operation is not performed, step S3 is repeated until the viewpoint change operation is performed.

On the other hand, when the viewpoint change operation is performed (step S3:YES), instruction determiner 130 determines the region where the designated position belongs (step S4).

Then, instruction determiner 130 determines the instruction of the user on the basis of the region determined at step S5, and viewpoint changer 140 determines the second viewpoint on the basis of instruction of the user, and changes the position of the viewpoint from the first viewpoint to the second viewpoint (step S5). Note that it is assumed that the second viewpoint is different from the first viewpoint.

Next, image generator 120 outputs the three-dimensional image corresponding to the second viewpoint to touch panel 20 (step S6). In this manner, touch panel 20 displays the three-dimensional image corresponding to the second viewpoint, and the user can visually recognize it.

In addition, at step S6, instruction determiner 130 sets a plurality of regions of the three-dimensional image corresponding to the second viewpoint such that the plurality of regions is different from the plurality of regions of the three-dimensional image corresponding to the first viewpoint. More specifically, the positions and areas of each region are changed (e.g., they are changed from the illustration of FIG. 4 to the illustration of FIG. 5).

While a procedure is described above, steps S3 to S6 may be repeated after step S6 until the user makes an instruction to terminate the display of the three-dimensional image, for example.

In addition, the first viewpoint determined at step S1 is not limited to the viewpoint of obliquely viewing vehicle V from above, and may be a viewpoint of viewing vehicle V from directly above, for example. In this case, the image displayed at step S2 described later is not a three-dimensional image as that illustrated in FIGS. 4 to 6, but is a perspective image of vehicle V as viewed from directly above (such as the image illustrated in FIG. 7).

Hereinabove, an operation of display controller 100 is described.

As elaborated above, display controller 100 of the present embodiment includes image generator 120 configured to generate a three-dimensional image showing the surroundings of vehicle V on the basis of images captured by a plurality of in-vehicle cameras (e.g., front camera 11, rear camera 12, left camera 13, and right camera 14) that captures the surroundings of vehicle V and display the image on display device (e.g., touch panel 20; the same shall apply hereinafter); and viewpoint changer 140 configured to changes the viewpoint parameter based on the position that is designated by the user operation on the three-dimensional image displayed on the display device, and output the three-dimensional image corresponding to the changed viewpoint parameter to the display device so as to display it. In the three-dimensional image displayed on the display device, a plurality of regions corresponding to different viewpoints (e.g., regions (1) to (8)) is set, and viewpoint changer 140 changes the viewpoint of the three-dimensional image on the basis of the region where the position on the three-dimensional image designated by the user belongs among the plurality of regions, and changes the plurality of regions in the three-dimensional image in accordance with the changed viewpoint.

Therefore, the user can intuitively make a viewpoint change instruction by designating (more specifically, touching) the desired position on the three-dimensional image, and thus the usability can be further improved.

In addition, in the related art, a technique in which a bird's-eye view of vehicle V as viewed from directly above and a three-dimensional image are displayed side by side and the viewpoint change operation is received in the bird's-eye view is known, but in the present embodiment, the viewpoint change operation can be received in the three-dimensional image, and thus the visibility can be improved, for example. In other words, a display controller according to the present embodiment includes: an image generator configured to generate a three-dimensional image of surroundings of a vehicle and output a display image to be displayed on a display device on a basis of the three-dimensional image, the three-dimensional image being generated on a basis of images captured by a plurality of in-vehicle cameras configured to capture the surroundings of the vehicle; an instruction determiner configured to determine an instruction of a user in accordance with a position operated by the user in the display image displayed on the display device; and a viewpoint changer configured to change a viewpoint parameter related to generation of the three-dimensional image on a basis of the instruction of the user determined by the instruction determiner. The instruction determiner sets a plurality of regions corresponding to different viewpoint parameters in the display image. The instruction determiner determines the instruction of the user on a basis of a region where the position operated by the user belongs among the plurality of regions. The viewpoint changer changes the viewpoint parameter in accordance with the instruction of the user. The instruction determiner sets the plurality of regions in the three-dimensional image after a change.

The present disclosure is not limited to the description of the above embodiments, and various variations are possible without departing from the intent of the disclosure. Modifications are described below.

### Modification 1

A plurality of regions in the three-dimensional image may be set such that the value of each area is equal to or greater than a preliminarily set threshold value.

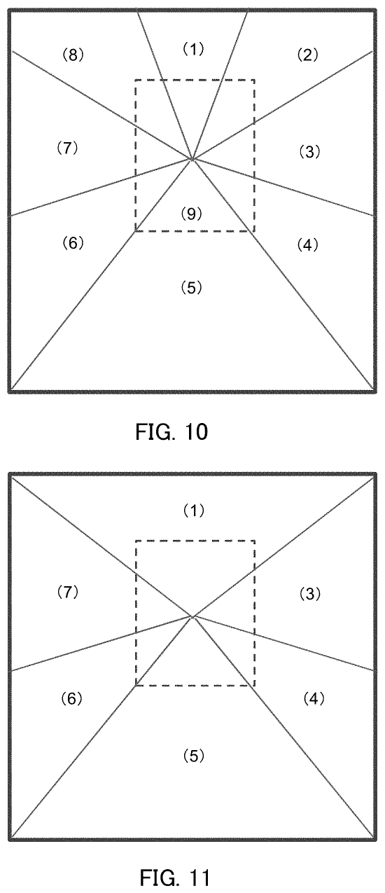

A specific example is described below with reference to FIGS. 10 and 11. FIG. 10 is a schematic view illustrating an exemplary first division in the case where the viewpoint is on the side right behind vehicle V. FIG. 11 is a schematic view illustrating an exemplary second division in the case where the viewpoint is on the side right behind vehicle V. Note that FIGS. 10 and 11 illustrate each region as viewed from directly above. In addition, in FIGS. 10 and 11, the illustration of vehicle image A is omitted.

In the three-dimensional image illustrated in FIG. 5, regions (1) to (9) are set as illustrated in FIG. 10. In this setting, the area of region (5) close to the viewpoint is large, while the area of region (1) remote from the viewpoint is small. Consequently, it is difficult for the user to properly touch region (1). For example, region (2) may be mistakenly touched when touching region (1).

In view of this, for example, regions (2) and (8) adjacent to region (1) may be merged into region (1) to enlarge region (1) as illustrated in FIG. 11, or the position of the boundary line may be further adjusted. In the case where there is a region with an area smaller than a preliminarily set threshold value, viewpoint changer 140 (or image generator 120) may merge the region into the adjacent region to reduce the total number of regions such that the region has an area equal to or greater than the threshold value, or may reduce the total number of regions in advance so as to set the boundary line such that the area of the region is equal to or greater than the threshold value, for example. In an operation of moving the viewpoint left and right when the viewpoint is located in region (5), the left and right movement of 45 degrees, the left and right movement of 90 degrees, or the movement of 180 degrees is performed in many cases, but the operation of moving the viewpoint left and right by 135 degrees is rare. Therefore, no practical problem occurs even when the region (2) and region (8) for the left and right movement by 135 degrees are eliminated.

In this manner, when the user performs the viewpoint change operation, erroneous pushing and the like can be prevented with the increased ease of touching, and thus the usability is further improved.

### Modification 2

In a plurality of regions in the three-dimensional image, the boundary line between adjacent regions may be set as a dead region when the user operation is not received. For example, the boundary line between the adjacent regions in a plurality of regions is set as a dead region where the user operation is not received, and the instruction determiner does not determine the instruction of the user when the user operates the dead region.

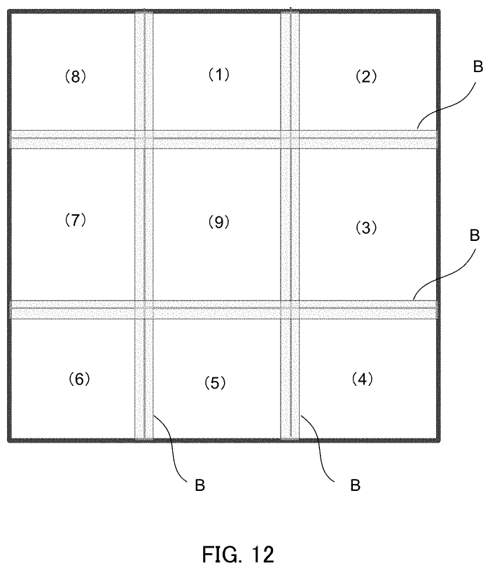

A specific example is described below with reference to FIG. 12. FIG. 12 is a schematic view illustrating an exemplary case where a dead region is set in the example of division of the region illustrated in FIG. 8. Note that FIG. 12 illustrates each region as viewed from directly above. In addition, in FIG. 12, the illustration of vehicle image A is omitted.

As illustrated in FIG. 12, dead region B is set at each boundary line. Each dead region B is wider than each boundary line illustrated in FIG. 5.

When the user touches dead region B, viewpoint changer 140 does not execute the change of the viewpoint, the corresponding change of the three-dimensional image, and the change of the plurality of regions.

For example, in the case where the user touches dead region B adjoining region (5) when touching the position inside region (5) when the three-dimensional image of FIG. 4 is being displayed, viewpoint changer 140 does not change the viewpoint to the side right behind vehicle V. In addition, viewpoint changer 140 maintains the display of the three-dimensional image of FIG. 4 without switching it to the display of the three-dimensional image of FIG. 5. In addition, since the display of the three-dimensional image of FIG. 4 is maintained, viewpoint changer 140 does not change regions (1) to (9) in the three-dimensional image of FIG. 4 to the positions and areas illustrated in FIG. 5, but maintains the positions and areas illustrated in FIG. 4.

In this manner, it is possible to prevent a situation where the user mistakenly touches the adjacent region when touching the desired region and as a result unintended viewpoint change is performed.

Note that dead region B may be temporarily displayed when the three-dimensional image is displayed such that the user can visually recognize it. In addition, it may be displayed only when touched by the user. For example, the boundary line and the dead region may not be displayed when the user does not operate the dead region, or the boundary line or the dead region may be displayed when the user operates the dead region. In this case, to improve the visibility of dead region B, dead region B may be displayed in an emphasized manner at a luminance different from that of other regions. Preferably, this luminance is set such that an after-image effect that allows the user to recognize the position of dead region B after the display of dead region B disappears.

In addition, dead region B may be temporarily displayed only when the user touches dead region B. In this case, for the sake of improving the visibility, it is preferable to display dead region B at a luminance different from that of other regions. By not displaying the dead region in a normal state, the visual recognition of the vehicle-surroundings image for the user is not blocked. By displaying it when the user makes a touch or when the dead region is touched, it is possible to touch the position that is properly determined in the next touch.

### Modification 3

The period until a predetermined time elapses from the viewpoint change operation may be set as a dead time period in which the viewpoint change operation is not received. When a user operation is performed in the dead time period, the instruction determiner does not determine the instruction of the user and therefore the change of the viewpoint is not performed.

In this case, even when the viewpoint change operation is performed in the dead time period, viewpoint changer 140 execute the change of the viewpoint, the corresponding change of the three-dimensional image, and the change of the plurality of regions on the basis of the viewpoint change operation performed before the dead time period. That is, viewpoint changer 140 invalidates the viewpoint change operation performed in the dead time period.

In this manner, even when the user mistakenly continuously performs the viewpoint change operation, the succeeding viewpoint change operations are invalidated, and thus the change to the unintended viewpoint can be suppressed.

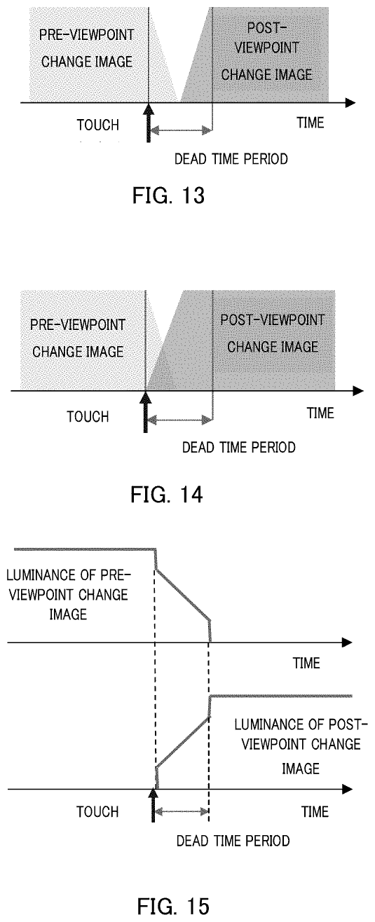

Further, in the dead time period, an effect process may be performed in the three-dimensional image displayed. A specific example is described below with reference to FIGS. 13, 14, and 15.

First, with reference to FIG. 13, a first effect process is described. FIG. 13 is a schematic view illustrating an image of the first effect process. The arrow from the left to right in the drawing indicates the elapsed time. In addition, in the drawing, the arrow from the lower side to the upper side indicates the timing of the viewpoint change operation (more specifically, touch operation) by the user. In addition, in the drawing, the two-headed arrow in the left-right direction indicates the dead time period.

As illustrated in FIG. 13, when a pre-viewpoint change image (a three-dimensional image before the viewpoint is changed) is displayed on touch panel 20 and a touch operation is performed, the dead time period starts from the time of the start of the operation. In this dead time period, viewpoint changer 140 controls touch panel 20 such that the pre-viewpoint change three-dimensional image fades out, and that a post-viewpoint change image (a three-dimensional image after the viewpoint is changed) to be displayed next fades in upon completion of the fade-out. In this manner, in the dead time period, the image is displayed such that the fade-in of the post-viewpoint change image is started at the same time as the completion of the fade-out of the pre-viewpoint change image. For example, in the dead time period, the pre-viewpoint parameter change three-dimensional image may be faded out, or the post-viewpoint parameter change three-dimensional image may be faded in, or, one or both effects may be performed.

Next, a second effect process is described with reference to FIG. 14. FIG. 14 is a schematic view illustrating an image of the second effect process. The arrows in FIG. 14 are the same as the arrows of in FIG. 13.

As illustrated in FIG. 14, when a pre-viewpoint change image is displayed on touch panel 20 and a touch operation is performed, the dead time period starts from the time of the start of the operation. In the dead time period, viewpoint changer 140 increases the transmittance of the pre-viewpoint change three-dimensional image while reducing the transmittance of the post-viewpoint change image to be displayed next. In other words, the blend ratio (mixing ratio) of the two images is continuously changed, for example. In this manner, in the dead time period, the pre-viewpoint change image gradually disappears while at the same time the post-viewpoint change image gradually appears. In other words, in the dead time period, this display controller continuously changes the blend ratio of the pre-viewpoint parameter change three-dimensional image and the post-viewpoint parameter change three-dimensional image.

Next, a third effect process is described with reference to FIG. 15. FIG. 15 is a schematic view illustrating an image of the third effect process. The arrows in FIG. 15 are the same as the arrows in FIG. 13.

As illustrated in FIG. 15, when the pre-viewpoint change image is displayed on touch panel 20 and the touch operation is performed, the dead time period starts from the time of the start of the operation. In the dead time period, viewpoint changer 140 controls touch panel 20 so as to reduce the luminance of the pre-viewpoint change three-dimensional image and increase the luminance of the post-viewpoint change image to be displayed next. In this manner, in the dead time period, the pre-viewpoint change image disappears and the post-viewpoint change image appears. As illustrated in FIG. 15, by changing the luminance at the start and the end of the dead time period, the time points of the start and end of the effect can be easily recognized than when the luminance is continuously changed.

Note that the transparency may be changed instead of the luminance. For example, in the dead time period, viewpoint changer 140 controls touch panel 20 so as to increase the transparency of the pre-viewpoint change three-dimensional image and reduce the transparency of the post-viewpoint change image to be displayed next. In this manner, in the dead time period, the pre-viewpoint change image disappears, and the post-viewpoint change image appears.

Hereinabove, the first to third effect processes are described. In the dead time period, the user operation is not received, and the user may feel poor responsiveness. However, when the above-described first to third effect processes are performed, a response to the user operation can be shown. Thus, the poor responsiveness recognized by user can be prevented, and the desire of the user to make continuous touch can be suppressed. In addition, the visual impact of the third effect process is greater than that of the first and second effect processes, which is more advantageous.

### Modification 4

In the period of the switch from the pre-viewpoint change three-dimensional image to the post-viewpoint change three-dimensional image, viewpoint changer 140 may continuously move the viewpoint from the pre-change viewpoint toward the post-change viewpoint, and output the corresponding three-dimensional image of the continuously moving viewpoint during a transition period after the completion of the output of the pre-viewpoint change three-dimensional image and until the output of the post-viewpoint change three-dimensional image so as to display it on touch panel 20.

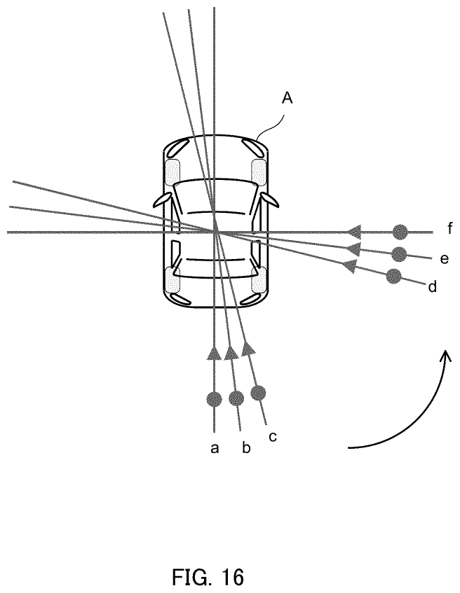

A specific example is described below with reference to FIG. 16. FIG. 16 is a schematic view illustrating an exemplary viewpoint change. The curved arrow in the drawing indicates the counterclockwise direction.

In FIG. 16, a to f represent viewpoints. Here, an exemplary case where the viewpoint is changed from a to f is described below. In the embodiment, the three-dimensional image corresponding to viewpoint f is displayed after the three-dimensional image corresponding to viewpoint a is displayed. In the present modification, after the three-dimensional image corresponding to viewpoint a is displayed, the three-dimensional images corresponding to viewpoints b, c, d and e are displayed in a transferring manner, and the three-dimensional image corresponding to viewpoint f is finally displayed.

Viewpoints b and c are positions at 5 degrees and 10 degrees, respectively from viewpoint a in the counterclockwise direction. Therefore, the three-dimensional image corresponding to viewpoint b is an image obtained by rotating counterclockwise the three-dimensional image corresponding to viewpoint a by 5 degrees, and the three-dimensional image corresponding to viewpoint c is an image obtained by rotating counterclockwise the three-dimensional image corresponding to viewpoint a by 10 degrees.

Viewpoints d and e are positions at 5 degrees and 10 degrees, respectively from viewpoint f in the clockwise direction. Therefore, the three-dimensional image corresponding to viewpoint d is an image obtained by rotating clockwise the three-dimensional image corresponding to viewpoint f by 5 degrees, and the three-dimensional image corresponding to viewpoint d is an image obtained by rotating clockwise the three-dimensional image corresponding to viewpoint f by 10 degrees.

That is, in the present modification, the three-dimensional images corresponding to viewpoints a, b, c, d, e and f are sequentially displayed, which is perceived by the user as smooth change of the position of the viewpoint, thus improving the visual impression. In addition, during the above-described transition display, users are likely to refrain from performing operations. Therefore, even when the time for performing the transition display is set in the dead time period in which the user operation is not received, it does not cause user dissatisfaction.

In addition, in the present modification, the three-dimensional image corresponding to the position from viewpoint c to viewpoint d is intentionally not displayed. The reason for this is that if the three-dimensional images corresponding to all positions each shifted by 5 degrees counterclockwise from viewpoint a to viewpoint f are continuously displayed, the user may irritate. By intentionally not displaying the continuous display as in the present modification, the irritation of the user can be avoided.

Note that the present modification describes an exemplary case where four three-dimensional images corresponding to viewpoints b, c, d and e are displayed in the period from the display of the three-dimensional image corresponding to viewpoint a to the display of the three-dimensional image corresponding to viewpoint f, but this is not limitative. For example, only two three-dimensional images corresponding to viewpoints b and c may be displayed, or only two three-dimensional images corresponding to viewpoints d and e may be displayed, or, one or two sections in which the viewpoint position is continuously changed may be set between the viewpoint c direction and the viewpoint d direction. In other words, when changing the viewpoint parameter in accordance with an instruction of the user, the viewpoint changer of the display controller of modification 4 continuously changes the viewpoint only in one or more predetermined ranges on a line connecting between the viewpoint before the change of the viewpoint parameter and the viewpoint instructed by the user. The line connecting been the viewpoint before the change of the viewpoint parameter and the viewpoint instructed by the user may be curved line or a straight line.

### Modification 5

In the embodiment, the viewpoint change operation by the user is described as the designation of the position on the three-dimensional image (e.g., the operation of touching the desired position on the three-dimensional image) as an example, but the viewpoint change operation is not limited to this, and may be the designation of the direction on the three-dimensional image, for example.

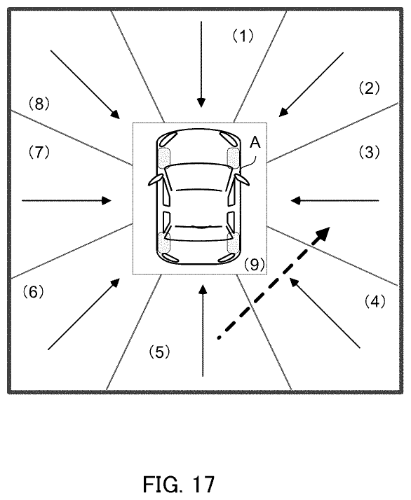

A specific example is described below with reference to FIG. 17. FIG. 17 is a schematic view illustrating exemplary line of sight and operation direction on a three-dimensional image.

As illustrated in FIG. 17, in the three-dimensional image, regions (1) to (9) are set as in FIG. 7. Further, lines of sight (solid-line arrows) different from each other are assigned to regions (1) to (8). The directions of the plurality of lines of sight different from each other are used as a reference for determining the viewpoint change operation of the user, and therefore may be referred to as reference direction. The plurality of reference directions is set by the instruction determiner in accordance with the three-dimensional image, but the setting of regions (1) to (9) is not necessarily essential. It suffices that when the viewpoint is changed, the reference direction is set in accordance with the post-change viewpoint. Like the size of the region that changes as the viewpoint changes in the example of FIG. 7, the reference direction is changed when the viewpoint is changed, and the angles between the plurality of reference directions are varied.

The user performs the operation of designating the desired direction (an example of the viewpoint change operation) on the three-dimensional image. For example, to change the viewpoint to the rear left side of vehicle V, the user performs a swipe of sliding the finger in the upper right direction (see the dotted line arrow in the drawing) on the displayed three-dimensional image. Note that while FIG. 17 illustrates an exemplary case where the swiped region is from region (5) to region (3) through region (4), this is not limitative, and the region may be any region on the image.

When the above-mentioned swipe is performed, instruction determiner 130 determines that the swiped direction is the upper right direction on the basis of a detection signal from touch panel 20, and specifies region (6) associated with the line of sight of the direction closest to the determined direction. Then, instruction determiner 130 determines that the position of the viewpoint to be changed is the rear left side of vehicle V on the basis of the specified region (6). The subsequent processes of viewpoint changer 140 are the same as those of the embodiment.

According to the present modification, the user can intuitively make a viewpoint change instruction by designating (more specifically, swiping) the desired direction on the three-dimensional image, and thus the usability can be further improved. In other words, a display controller according to the present modification includes: an image generator configured to generate a three-dimensional image of surroundings of a vehicle and output a display image to be displayed on a display device on a basis of the three-dimensional image, the three-dimensional image being generated on a basis of images captured by a plurality of in-vehicle cameras configured to capture the surroundings of the vehicle; an instruction determiner configured to determine an instruction of a user on a basis of a direction designated by an operation by the user on the display image displayed on the display device; and a viewpoint changer configured to change a viewpoint parameter related to generation of the three-dimensional image in accordance with the instruction of the user determined by the instruction determiner. The instruction determiner sets a plurality of reference directions corresponding to different viewpoint parameters. The instruction determiner determines a reference direction close to the direction designated by the operation by the user among the plurality of reference direction. The viewpoint changer changes the viewpoint parameter on a basis of a result determined by the instruction determiner. The instruction determiner sets the plurality of reference directions in the three-dimensional image in accordance with a viewpoint after a change.

### Modification 6

In modification 5, an exemplary case where the direction is determined as the viewpoint change operation of the user is described on the premise that a plurality of regions or a plurality of reference directions (lines of sight) are set on a three-dimensional image, but the above-mentioned premise may be omitted.

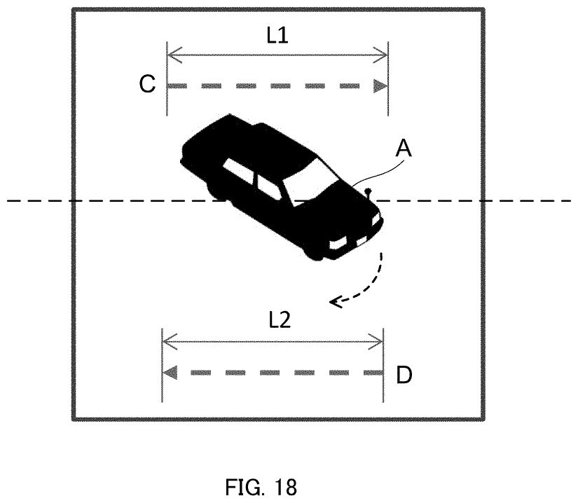

A specific example is described below with reference to FIG. 18. FIG. 18 is a schematic view illustrating an operation direction on a three-dimensional image. The viewpoint of the three-dimensional image illustrated in FIG. 18 is a front right side of vehicle V. For example, the initial value of the viewpoint of the three-dimensional image may be the side just above the vehicle such that the viewpoint moves to the viewpoint illustrated in FIG. 18 when the user touches the region of the front right side of vehicle V and that thereafter the viewpoint can be moved by a swipe.

For example, to change the viewpoint to the front left side of the vehicle V during the display of the three-dimensional image of FIG. 18, the user performs a swipe of sliding the finger from left to right in the upper half region (the region above the dashed line in the drawing) in the three-dimensional image. Dotted line arrow C in the drawing indicates the swipe direction. In addition, L1 indicates the operation amount of the swipe (i.e., the movement amount of the finger).

In this case, instruction determiner 130 determines that an instruction to move the viewpoint clockwise like vehicle image A rotates clockwise (see the curved dotted line arrow) is made on the basis of the detection signal of touch panel 20. When vehicle image A rotates clockwise, the left front side of vehicle image A will be located on the near side, and therefore instruction determiner 130 determines that the position of the viewpoint to be changed is the front left side of vehicle V. The subsequent processes of viewpoint changer 140 are the same as those of the embodiment.

Note that to change the viewpoint to the front left side of vehicle V, the user may perform a swipe of sliding the finger from right to left in the lower half region (the region below the dashed line in the drawing) in the three-dimensional image. Dotted line arrow D in the drawing indicates the swipe direction. In addition, L2 indicates the operation amount of the swipe (i.e., the movement amount of the finger). In modification 5, the direction designated by the user operation is determined in comparison with the plurality of reference directions, while in modification 6, the amount of the change of the viewpoint or the line of sight may be determined by comparing the operation amount with a plurality of threshold values.

In this case, for example, on the basis of the detection signal of touch panel 20, instruction determiner 130 determines that an instruction to move the viewpoint by 45 degrees clockwise like vehicle image A rotates clockwise (see the curve dotted line arrow) and determines that the position of the viewpoint to be changed is the front left side of vehicle V.

According to the present modification, the user can intuitively make an instruction of viewpoint change by designating (more specifically, swiping) the desired direction on the three-dimensional image, and thus the usability can be further improved. In addition, the present modification can be easily achieved because the premise of modification 5 is not required.

Note that while an exemplary case where the direction of the swipe is the left-right direction is described above as an example, the direction may be the up-down direction. For example, when a swipe from the top to bottom in the left half region of the three-dimensional image or a swipe from the bottom to top in the right half region of the three-dimensional image is performed, instruction determiner 130 may determine that an instruction to move the viewpoint counterclockwise like vehicle image A rotates counterclockwise is made. Then, instruction determiner 130 may determine the position of the viewpoint on the basis of the rotational direction of vehicle image A.

In addition, the operation amount (e.g., L1 and L2) or the operation speed of the swipe may be taken into account in addition to the direction of the swipe. More specifically, the rotation amount of vehicle image A may be increased as the operation amount of the swipe (e.g., the longer the L1 and L2) increases, or the rotation amount of vehicle image A may be increased as the operation speed of the swipe increases. For example, in the case where the viewpoint position is changed from the direct upper side to the oblique upper side, the image of vehicle image A is displayed large in the left-right direction in the lower portion of the display image while the image of vehicle image A is displayed little in the up-down direction. Therefore, when the lower portion of the display image is swiped in the left-right direction, the rotation amount of vehicle image A corresponding to the operation amount of the swipe may be reduced than when the left and right sides of the image of vehicle image A are swiped in the up-down direction.

In other words, a display controller according to the modification 6 includes: an image generator configured to generate a three-dimensional image of surroundings of a vehicle and output a display image to be displayed on a display device on a basis of the three-dimensional image, the three-dimensional image being generated on a basis of images captured by a plurality of in-vehicle cameras configured to capture the surroundings of the vehicle; and a viewpoint changer configured to change a viewpoint parameter on a basis of a position of a swipe and one of an operation amount and an operation speed of the swipe when the swipe is performed by a user on the three-dimensional image displayed on the display device.

Hereinabove, the modifications are described. The above mentioned variations may be combined as appropriate to the extent that the intent is not departed from.

While various embodiments have been described herein above, it is to be appreciated that various changes in form and detail may be made without departing from the spirit and scope of the invention (s) presently or hereafter claimed.

This application is entitled to and claims the benefit of Japanese Patent Application No. 2022-066500 filed on Apr. 13, 2022, the disclosure each of which including the specification, drawings and abstract is incorporated herein by reference in its entirety.

### INDUSTRIAL APPLICABILITY

The display controller of the present disclosure is generally useful for the techniques of displaying a three-dimensional image of the surroundings of a vehicle.

### REFERENCE SIGNS LIST

1 Display system
10 Image-capturer
11 Front camera
12 Rear camera
13 Left camera
14 Right camera
20 Touch panel
100 Display controller
110 Image acquirer
120 Image generator
130 Instruction determiner
140 Viewpoint changer
V Vehicle

1. A display controller comprising:
an image generator configured to generate a three-dimensional image of surroundings of a vehicle and output a display image to be displayed on a display device on a basis of the three-dimensional image, the three-dimensional image being generated on a basis of images captured by a plurality of in-vehicle cameras configured to capture the surroundings of the vehicle;
an instruction determiner configured to determine an instruction of a user in accordance with a position operated by the user in the display image displayed on the display device; and
a viewpoint changer configured to change a viewpoint parameter related to generation of the three-dimensional image on a basis of the instruction of the user determined by the instruction determiner,
wherein the instruction determiner sets a plurality of regions corresponding to different viewpoint parameters in the display image,
wherein the instruction determiner determines the instruction of the user on a basis of a region where the position operated by the user belongs among the plurality of regions,
wherein the viewpoint changer changes the viewpoint parameter in accordance with the instruction of the user, and
wherein the instruction determiner sets the plurality of regions in the three-dimensional image after a change.

2. The display controller according to claim 1, wherein the plurality of regions is set such that respective areas are equal to or greater than a preliminarily set threshold value.

3. The display controller according to claim 1,
wherein a boundary line between adjacent regions in the plurality of regions is set as a dead region where the user operation is not received, and
wherein the instruction determiner does not determine the instruction of the user when the dead region is operated by the user.

4. The display controller according to claim 3,
wherein the boundary line and the dead region are not displayed when the dead region is not operated by the user, and
wherein the boundary line or the dead region is displayed when the dead region is operated by the user.

5. A display controller comprising:
an image generator configured to generate a three-dimensional image of surroundings of a vehicle and output a display image to be displayed on a display device on a basis of the three-dimensional image, the three-dimensional image being generated on a basis of images captured by a plurality of in-vehicle cameras configured to capture the surroundings of the vehicle;
an instruction determiner configured to determine an instruction of a user on a basis of a direction designated by an operation by the user on the display image displayed on the display device; and
a viewpoint changer configured to change a viewpoint parameter related to generation of the three-dimensional image in accordance with the instruction of the user determined by the instruction determiner,
wherein the instruction determiner sets a plurality of reference directions corresponding to different viewpoint parameters,
wherein the instruction determiner determines a reference direction close to the direction designated by the operation by the user among the plurality of reference direction,
wherein the viewpoint changer changes the viewpoint parameter on a basis of a result determined by the instruction determiner, and
wherein the instruction determiner sets the plurality of reference directions in the three-dimensional image in accordance with a viewpoint after a change.

6. The display controller according to claim 5, wherein the plurality of reference directions is set such that a difference between angles is equal to or greater than a preliminarily set threshold value.

7. A display controller comprising:
an image generator configured to generate a three-dimensional image of surroundings of a vehicle and output a display image to be displayed on a display device on a basis of the three-dimensional image, the three-dimensional image being generated on a basis of images captured by a plurality of in-vehicle cameras configured to capture the surroundings of the vehicle; and
a viewpoint changer configured to change a viewpoint parameter on a basis of a position of a swipe and one of an operation amount and an operation speed of the swipe when the swipe is performed by a user on the three-dimensional image displayed on the display device.

8. The display controller according to claim 1, wherein when changing the viewpoint parameter in accordance with an instruction of the user, the viewpoint changer continuously changes a viewpoint only in predetermined one or a plurality of ranges on a line connecting between a viewpoint before a change of the viewpoint parameter and a viewpoint instructed by the user.

9. The display controller according to claim 1,
wherein a dead time period in which an operation of the user is not received is set in a period until a predetermined time elapses after the viewpoint parameter is changed, and
wherein the instruction of the user is not determined when an operation is performed by the user in the dead time period.

10. The display controller according to claim 9, wherein in the dead time period, one or both of fade-out of the three-dimensional image before a change of the viewpoint parameter, and fade-in of the three-dimensional image after a change of the viewpoint parameter are performed.

11. The display controller according to claim 9, wherein in the dead time period, a blend ratio between the three-dimensional image before a change of the viewpoint parameter and the three-dimensional image after a change of the viewpoint parameter is continuously changed.

12. The display controller according to claim 9, wherein in the dead time period, a luminance of the three-dimensional image before a change of the viewpoint parameter is reduced, or a luminance of the three-dimensional image after a change of the viewpoint parameter is increased.

13. The display controller according to claim 9, wherein in the dead time period, a transparency of the three-dimensional image before a change of the viewpoint parameter is increased, and a transparency of the three-dimensional image after a change of the viewpoint parameter is reduced.

14. A display device configured to be controlled by the display controller according to claim 1.

15. A vehicle in which the display controller according to claim 1 is mounted.
